(19) United States
(12) Patent Application Publication
(10) Pub. No.: US 2013/0186346 A1
(43) Pub. Date: Jul. 25, 2013

(54) DECORATIVE WATER DISPLAY HAVING SOUND AND LIGHTING

(71) Applicants: Dennis R. Milford, Olathe, KS (US); J. David Wharton, Kansas City, MO (US); Chunlin Xiao, Heng Yang (CN)

(72) Inventors: Dennis R. Milford, Olathe, KS (US); J. David Wharton, Kansas City, MO (US); Chunlin Xiao, Heng Yang (CN)

(73) Assignee: KOLLER ENTERPRISES, INC., Fenton, MO (US)

(21) Appl. No.: 13/355,166

(22) Filed: Jan. 20, 2012

(51) Int. Cl. A01K 63/00; B32B 1/06; F21V 33/00; A01K 63/06

(52) U.S. Cl. 119/247; 119/245; 119/267; 428/14; 362/101

(57) ABSTRACT

A decorative water display includes a container for holding water, an art piece adapted to be immersed in the water, and a sound module mounted on the container operable to play a prerecorded audio recording through a speaker device. The water display may further include a light source, the light may further be varied in coordination with the audio recording to produce a synergistic artistic expression. The water display may comprise an aquarium. The invention also encompasses storing the audio recording on a removable memory component to accommodate different tastes.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to decorative water displays.

2. Description of Related Art

Decorative water displays, such as aquariums and the like, are known in the art. Ornamental water displays for indoor use are known and, in some cases, include water circulating pumps while in other cases the water is static. Aquariums utilizing circulating pumps to aerate the water are well known and in some cases include artwork immersed in the aquarium. The decorative appearance of such displays and their contents providing a pleasing aesthetic visual appearance to their owners. Various lighting apparatus are often used to further enhance the visual appearance of the water display and to illuminate the contents for easier viewing.

### BRIEF SUMMARY OF THE INVENTION

This invention relates generally to water displays and, more particularly, to a water display which includes a sound module that plays sounds through a speaker device to accompany and enhance the visual appearance of the display. In an exemplary embodiment, the invention comprises a decorative water display which includes a container for holding water, an art piece adapted to be immersed in the water, and a sound module mounted on the container operable to play a prerecorded audio recording through a speaker device.

The water display may further include a light source and it is within the scope of the invention to coordinate the playback of the audio recording with the light source to produce a synergistic artistic expression. The invention also encompasses storing the audio recording on a removable memory component to accommodate different tastes.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a decorative water display in accordance with an exemplary embodiment of the present invention.

FIG. 2 is front perspective view of a removable sound and light module component of the water display of FIG. 1.

FIG. 3 is a bottom, plan view of the removable sound and light module component of FIG. 2.

FIG. 4 is a top, plan view of a the removable sound and light module component of FIG. 2.

FIG. 5 is a block diagram of the electronic circuitry of the removable sound and light module component of FIG. 2.

### DETAILED DESCRIPTION OF EXEMPLARY EMBODIMENTS

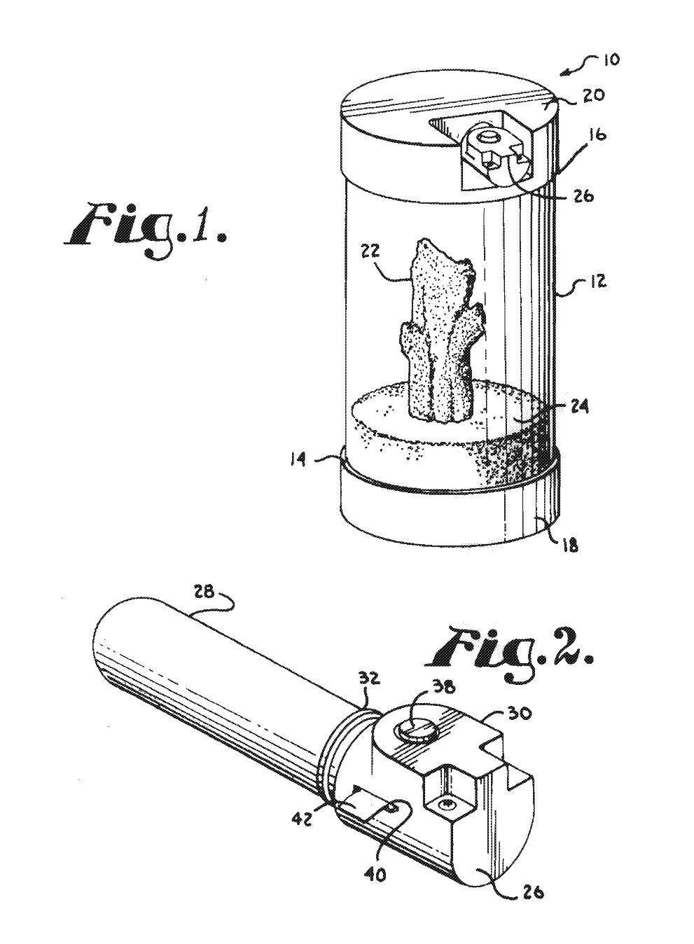

Looking first to FIG. 1, a decorative water display in accordance with an exemplary embodiment of the present invention is depicted generally by numeral 10. Decorative water display 10 includes a generally cylindrical, water-holding container 12 extending between a lower end 14 and an upper end 16. Lower end 14 is supported on base 18, with upper end 16 covered by lid 20. An art piece 22 is positioned within the container such that the art piece will be at least partially submerged within water placed into container 12. The art piece is attached to the base, or is supported in sand or gravel 24 dispersed along the bottom of the lower end of the container, adjacent to base 18. Lid 20 houses a sound module component 26 (described in more detail below) removably received into a cavity in the lid, with the module's controls and media slot (described below) accessible from the top and side of the lid so that a user may access the controls when the sound module is mounted in the lid.

Container 10 is preferably formed of a rigid, transparent material such as plastic. Most preferably, container 10 is acrylic. Base 18 and lid 20 are preferably formed of a rigid, water impervious material, such as plastic. Lid 20 is preferably removably positioned onto upper end 16 of container 10. Most preferably lid 20 includes tabs, slots, or other alignment features configured to evenly position the lid upon the open upper end of the container.

Art piece 22 may be any decorative piece such as a sculpture or other art work. Preferably, art piece 22 is water impervious, although works of art that alter upon exposure to water are also anticipated by the present invention. As seen in FIG. 1, with art piece 22 positioned within container 10, supported by sand or gravel 24 or attached to base 18, water introduced into the container will begin to cover the art piece as the container is filled. The level of the water may be varied so that the art piece is either partially or fully submerged.

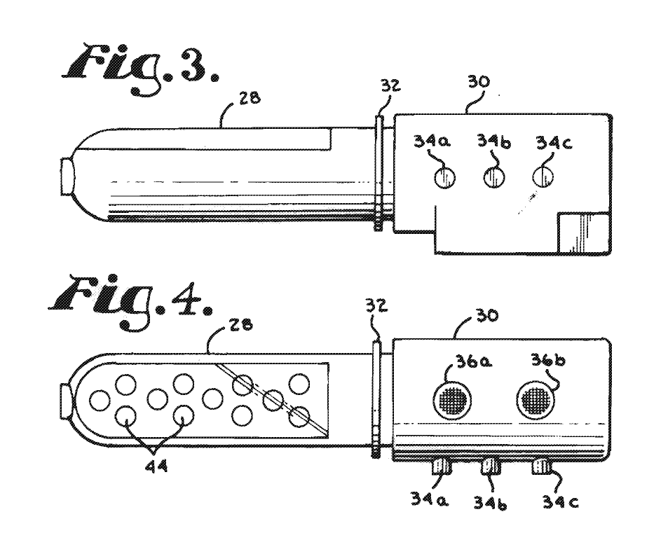

Turning to FIGS. 2 through 4, sound module component 26 comprises a generally cylindrical, elongated, lamp portion 28 attached to a shorter, control portion 30 housing electronic circuitry as will be described in more detail below. Lip 32 extends circumferentially around the inner end of lamp portion 28, separating the lamp portion 28 from the control portion 30. Lip 32 serves as a stop when sound module 26 is inserted within the cavity of lid 22 (as described above) and can be turned 90° to lock it in place in a manner well known to those skilled in the art.

Elongated lamp portion 28 includes a plurality of light emitting diodes (“LEDs”) 44 positioned along the length of the underside of sound module 26. As can be seen in FIG. 1, with the sound module positioned within the cavity of lid 20, the LEDs are positioned above the art piece 22 in the container 10 so that light from the LEDs is directed downwardly towards the art piece, thus providing illumination to the art piece and the interior of the container. LEDs 44 may all be a single color, or may be a combination of various available LED colors. Switch 38 is operable through the control circuitry to control power to the LEDs, preferably the switch turns the LEDs on and off upon successive presses of the switch.

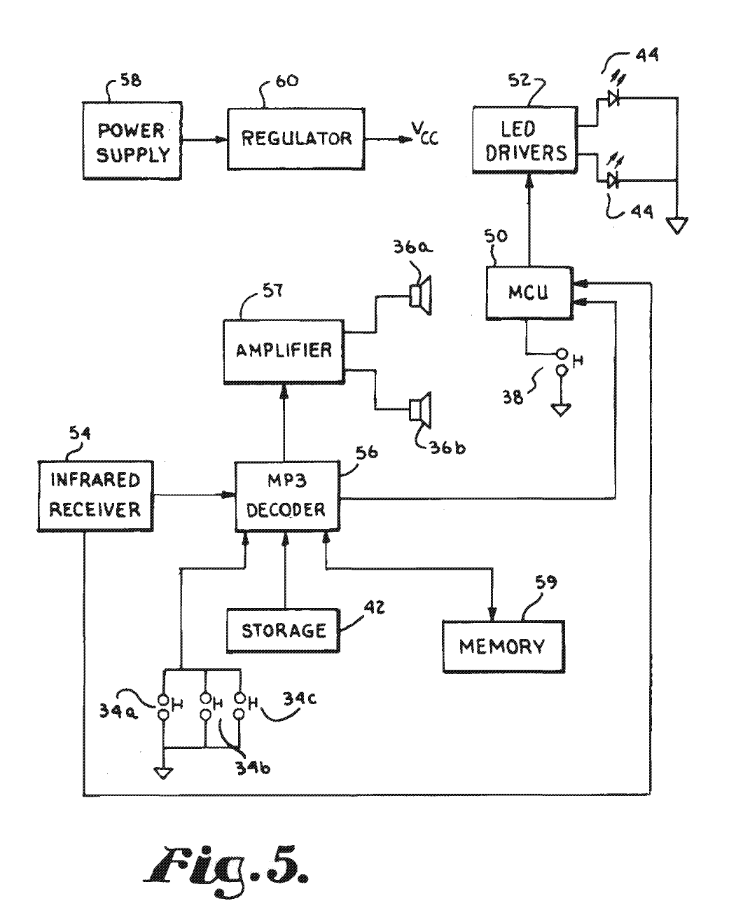

As seen in FIGS. 3 and 4, control portion 30 includes a plurality of audio control switches 34a, 34b, 34c, a pair of speaker devices 36a, 36b, and a power switch 38, all operable with the control circuitry. Control portion 30 further includes a slot 40 to receive a removable media card 42 having one or more prerecorded audio sound files. Preferably, media card 42 is a micro sized secure digital high capacity (SDHC) flash memory device. Media card 42 preferably includes at least one sound recording, preferably stored in the MP3 format. Audio control switches 34a, 34b, and 34c are preferably push button switches, operable to control the playback of the MP3 sound recording through the MP3 circuitry (described in more detail below). The switches are preferably operable to control audio playback features such as, start, stop, fast forward, rewind, volume, next track, previous track, and selecting a recording for playback. Speaker devices 36a, 36b are operable with the amplifier portion of the control circuitry (as described in more detail below) to translate the electrical signal produced by the MP3 circuitry to an audible signal.

Looking to FIG. 5, the operation of the control circuitry and the switches, speaker devices, and media card just set forth will now be described. FIG. 5 depicts a block diagram of an exemplary embodiment of the control circuitry of sound module 30 is depicted. The control circuitry includes a microcontroller unit (“MCU”) 50 operable to execute programmed instructions, to monitor inputs and to control outputs according to those programmed instructions. MCU 50 may be any microcontroller known in the art having the capabilities to perform the functions described herein. Preferably, MCU 50 includes onboard read only memory for storing program steps, and random access memory for storing data and variables used by the operating program. MCU 50 is in communication with LED drivers circuitry 52, infrared receiver circuitry 54, and MP3 decoder circuitry 56. Power switch 38 is used to turn power to the LEDs and/or the entire control module, on and off.

LED driver circuitry 52 is operable to supply power to the plurality of LEDs 44 upon a command signal from MCU 50 (as described above, LEDs 44 are positioned along the length of sound module 30 to provided illumination to the art piece and the interior of the container). Switch 38 is preferably operable to turn LEDs 44 on and off. It should be understood that while a single line is depicted connecting MCU 50 and LED Drivers 52 in FIG. 5, as is known in the art, the control between the MCU and driver circuitry may comprise multiple, individual control lines, or may comprise a multiplexed or composite signal having control information relating to multiple LEDS. Thus, MCU 50 can direct any or all (or any combination thereof) of the LEDs 44 to illuminate or extinguish by providing the appropriate command to the LED driver circuitry. For example, the MCU may command all of the LEDs to illuminate simultaneously, or it may command only a subset of the plurality of LEDs to illuminate. Furthermore, the individual LED's may be capable of illuminating in multiple colors (e.g., by changing the polarity of the signal to the LED), in which case the driver circuitry would be adapted to provide that capability and the MCU could command the LED to illuminate in the desired color. These and other variations of controlling the LEDs are within the scope of the present invention.

MP3 decoder circuitry 56 is operable to communicate with storage device 42 (the removable media card previously described) and to read from the device a preprogrammed sound recording stored preferably in the MP3 format. The MP3 circuitry translates the MP3 encoded sound file to an analog electrical signal, which is communicated to amplifier circuitry 57 which amplifies the signal to driver speaker devices 36a, 36b (located in the sound module as described previously) which produce an audible signal corresponding to the sound recording being played back. Speaker devices 36a, 36b convert the electrical signal received from the amplifier circuitry 57 to an acoustical wave, preferably in the form of a human-perceptible sound. The speaker devices are preferably a miniature Mylar speakers positioned on the chassis the sound module 30.

MP3 decoder circuitry 56 is also in communication with memory 59, which is used by the decoder circuitry in the translation and decoding of the MP3 sound file, and is in communication with MCU 50 such that the MCU can monitor the sound file being played so that, for example, the LEDs may be illuminated in coordination with the sound file. Control switches 34a, 34b, and 34c are in electrical communication with MP3 decoder circuitry 56 to control the playback of the MP3 sound file.

Infrared receiver circuitry 54 is operable to receive an infrared signal from a remote control device and communicate a detected control signal to the MP3 circuitry 56. Thus, in addition to being controllable via switches 34a, 34b, and 34c, the MP3 circuitry may be controlled remotely by a user to control audio playback functions such as starting, stopping, fast forward, rewind, volume, and the like.

Power supply circuitry 58 and regulator circuitry 60 provide power to all of the other circuitry components, as is known in the art. Preferably, power supply 58 is a battery pack or direct current (DC) supply powered by standard 120 or 220 volt AC mains power. Regulator circuitry 60 is operable to provide a stable, regulated DC supply to the other circuitry blocks described herein. For clarity of the block diagram, lines connecting the Vcc power from the regulator circuitry to the other circuitry is not shown, however it is understood that the regulated power is available to all of the circuitry depicted and contained in the control module 30.

In operation and use, an art piece 22 is positioned in container 10 and the container is at least partially filled with water. A removable media card 42 is inserted into slot 40 of the control module 30, and the module is positioned into lid 20 and powered on using power switch 38. Using either a remote control in communication with infrared circuitry 54, or using control switches 34a, 34b, 34c, a user commands playback of a prerecorded MP3 sound file from the media card. The MP3 decoder circuitry reads the file from the card, translates the digital information in the file to an electrical signal, and transmits the signal to the amplifier circuitry. The amplifier circuitry increases the strength of the signal and transmits to the speaker devices which convert the electrical signal to an audible signal, thus audibly playing the music or sound from a sound file. In conjunction with playback of the sound file, the MCU may illuminate the LEDs either continuously, with the power turned on using switch 38, or may illuminate the LEDs in a predetermined or random pattern, or in coordination with the playback of the sound recording. The overall effect of the decorative water display is an art piece displayed within a container filled (or partially filled) with water, the art piece being illuminated in conjunction with the playback of an accompanying audio track. “Art piece” is understood to include any natural or man-made object of any size having a decorative effect.

The embodiments described above are intended to be illustrative, and not limiting. Variations of the specific embodiments described are anticipated by, and are within the scope of, the present invention.

For example, slot 40 of the sound module is described as being configured to receive a micro SDHC media card. Other types of storage media, such as full size or mini SDHC cards may be used with a corresponding slot configured to receive the card. Or, slot 40 could be a universal serial bus (USB) configuration, with media card 42 being a USB flash drive. These and other configurations of media storage and corresponding receptacles are within the scope of the present invention. The audio circuit may also be fixed. Similarly, while the light source is shown to comprise LEDs 44, other lighting elements known in the art, such as incandescent bulbs or neon bulbs could be used within the scope of the present invention. And, while speaker devices 36a, 36b are described as Mylar speakers, other sound transducer devices such as piezoelectric transducers or electromechanical loudspeakers may be used without deviating from the scope of the present invention.

While the sound module depicted and described includes both a light source and audio circuitry, it should be understood that the light source may be separated from the sound module and mounted separately to the lid or housing of the container, or that the sound module may not include any light source whatsoever. While the sound module is preferable in MP3 format, it could also be in MP4, WMA, or any other format.

Container 12 may be any shape, and need not be the cylindrical shape depicted in the exemplary embodiments. Container 12 may comprise an aquarium. It is understood that “aquarium” includes any container for holding a visual water display of either artificial objects or live plants and fish or some combination. The lid may comprise a housing that encompasses the sound module and light source, or the sound module and light source may mount to the container separately from the lid and housing. These and other variations are also within the scope of the present invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A decorative water display comprising:
a container for holding water;
an art piece adapted to be immersed in said water when said container is at least partially filled with water; and
a sound module mounted on said container, said sound module operable to play a sound recording through a speaker device.

2. A decorative water display as set forth in claim 1, wherein said container includes a lid and said sound module is mounted to said lid.

3. A decorative water display as set forth in claim 1, wherein is included a light source mounted on said container.

4. A decorative water display as set forth in claim 3, wherein said light source is variable and may be varied in response to an audio output of said sound module.

5. A decorative water display as set forth in claim 1, wherein is included a housing mounted on said container and a light source mounted in said housing, said sound module and said speaker device also being mounted in said housing.

6. A decorative water display as set forth in claim 5, wherein is included a power source for said light source and said sound module.

7. A decorative water display as set forth in claim 5, wherein said housing comprises a lid.

8. A decorative water display as set forth in claim 1 wherein said container comprises an aquarium.

9. A decorative water display as set forth in claim 8, wherein said light source may be varied in intensity, color, or combinations thereof.

10. A decorative water display as set forth in claim 1, wherein said sound module comprises a removable media embodying said sound recording such that said sound recording may be replaced by an alternate sound recording by replacing said removable media.

11. The decorative water display as set forth in claim 10, wherein said removable media embodies a plurality of sound recordings and wherein a specific sound recording is selectable by a user.

12. A device for use within an aquarium, said device comprising:
a housing;
a light source received in said housing; and
a sound module received in said housing, said sound module comprising a speaker device operable to play a sound recording.

13. A device as set forth in claim 12 wherein is included a power source for said light source and said sound module.

14. A device as set forth in claim 13, wherein said light source is variable and may be varied in response to the audio output of said sound recording.

15. A device as set forth in claim 14, wherein said light source may be varied in intensity, color, or combinations thereof.

16. A device as set forth in claim 12, wherein said sound recording is replaceable by an alternate sound recording.

17. A device as set forth in claim 16, wherein said sound recording comprises a removable media embodying said sound recording such that said sound recording may be replaced by an alternate sound recording by replacing said removable media.

18. The device as set forth in claim 17, wherein said removable media embodies a plurality of sound recordings and wherein a specific sound recording is selectable by a user.

19. The device as set forth in claim 18, wherein said removable media is selected from the group comprising a flash drive, a memory card, and a memory stick.

20. An aquarium comprising:
a container for holding water;
a housing mounted on said container;
a light source received in said housing; and
a sound module received in said housing, comprising a speaker device operable to play a sound recording.

21. A device as set forth in claim 20, wherein is included a power source for said light source and said sound module.

22. A device as set forth in claim 21, wherein said light source is variable and may be varied in response to the audio output of said sound recording.

23. A device as set forth in claim 20, wherein said sound recording is replaceable by an alternate sound recording.

24. A device as set forth in claim 23, wherein said sound recording comprises a removable media embodying said sound recording such that said sound recording may be replaced by an alternate sound recording by replacing said removable media.
